(19) United States
(12) Patent Application Publication
(10) Pub. No.: US 2002/0097346 A1
(43) Pub. Date: Jul. 25, 2002

(54) Television with a built-in receptacle for its remote control

(76) Inventor: Shiao-Hua Chen, Palo Alto, CA (US)

Correspondence Address: Shiao-Hua Chen, 3227 Stockton Place, Palo Alto, CA, 94303, US

(21) Appl. No.: 09/771,081

(22) Filed: Jan. 25, 2001

(51) Int. Cl. H04N 5/64

(52) U.S. Cl. 348/836

(57) ABSTRACT

The invention is about a television that has a built-in receptacle such that its remote control can be placed in the receptacle. In addition, the presence of the remote control in the receptacle turns OFF the TV while removal of it turns ON the TV. Such a remote control, by design, lacks the function to remotely turn ON or OFF the TV. This would drastically reduce the possibility of a missing or misplaced remote control. The built-in receptacle may also allow storage of spare batteries for the remote control.

### BACKGROUND: FIELD OF INVENTION

The invention relates to a television and its remote control.

### BACKGROUND: DESCRIPTION OF THE RELATED ART

As shown in FIG. 1, today's typical television 11 comes with a remote control 12. A remote control brings great convenience to TV watchers. It normally allows the following functions: ON/OFF, Channel Change, Volume Change, Mute et al. Because of the availability of a remote control, many TV manufacturers are able to minimize the redundant manual control buttons/keypads on the main console. For example, only ON/OFF 13, Channel UP/DOWN 14 and Volume UP/DOWN 15 functions are manually accessible.

However, from time to time, a TV watcher may find himself frustratingly trying to locate the remote control before he can settle down to his seat. This is so common since most TV's are shared by more than one individual. One may never know, at least not intuitively, where the remote control is “hidden” by the last TV watcher. Now if the remote control is indeed not located at the moment, any watcher trying to go from channel, say, 9 to 54 should know how “painful” it is to firstly go toward the TV and then repeatedly push the channel UP button.

Accordingly, there is a need for a simple and convenient way to avoid the “missing or misplaced remote control” situation.

### BRIEF SUMMARY OF THE INVENTION

The invention is about a television that has a built-in receptacle such that its remote control can be placed in the receptacle. In addition, the presence of the remote control in the receptacle turns OFF the TV while removal of it turns ON the TV. Such a remote control, by design, lacks the function to remotely turn ON or OFF the TV. This would drastically reduce the possibility of a missing or misplaced remote control. The built-in receptacle may also allow storage of spare batteries for the remote control.

### BRIEF DESCRIPTION OF THE DRAWINGS

In the drawings, the suffixes are designated as follows:

A: Front View

B: Right Side View

FIG. 1 is a television and its remote control of prior art.

FIG. 2 is a preferred embodiment of a television with a built-in receptacle for its remote control. The remote control is in the receptacle.

FIG. 3 is same as FIG. 2 except that the remote control is removed from the receptacle.

FIG. 4 is an embodiment of another television with a built-in receptacle for its remote control. The remote control is in the receptacle.

### DETAILED DESCRIPTION OF THE INVENTION

FIG. 2 shows the preferred embodiment of the invention. The TV 21, with a remote control 22, is featured with a built-in receptacle 23, which serves to be the “home” for its remote control 22. The top portion of the remote control is shaped like a telephone's ear (/mouth) piece that allows it to be hung onto the receptacle.

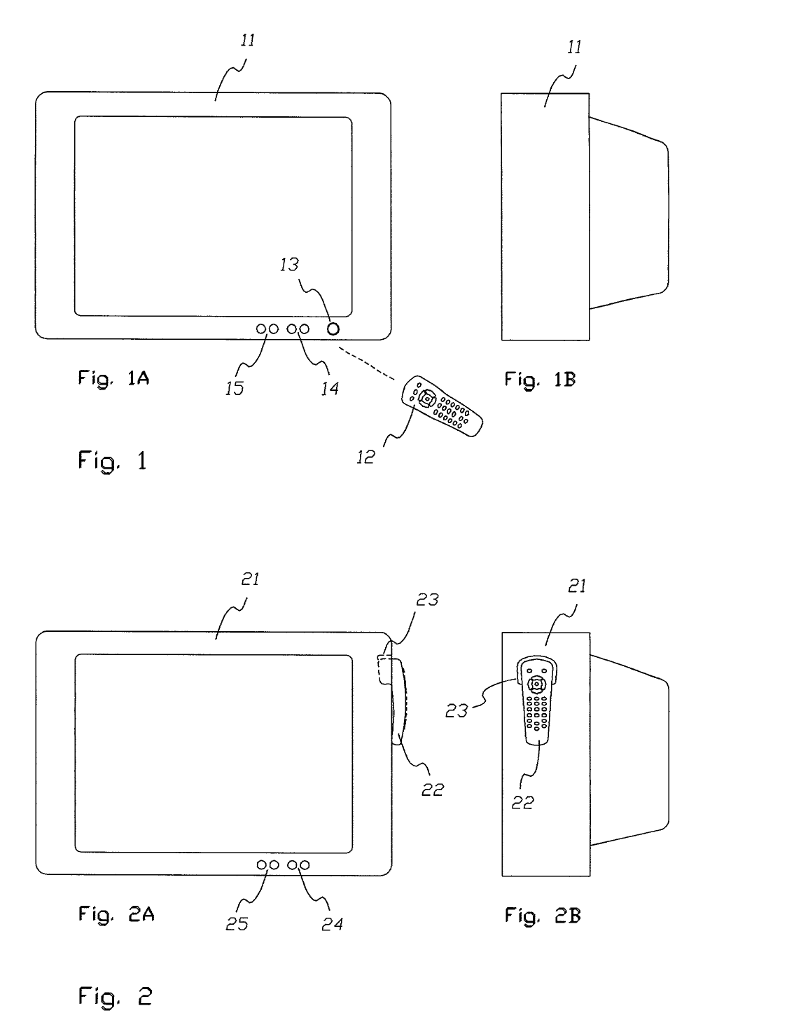

This TV also has Channel UP/DOWN buttons 24 and Volume UP/DOWN buttons 25, similar to those of prior art as illustrated in FIG. 1. However, unlike a TV of prior art, this one does not have an ON/OFF button like the one (13) in FIG. 1.

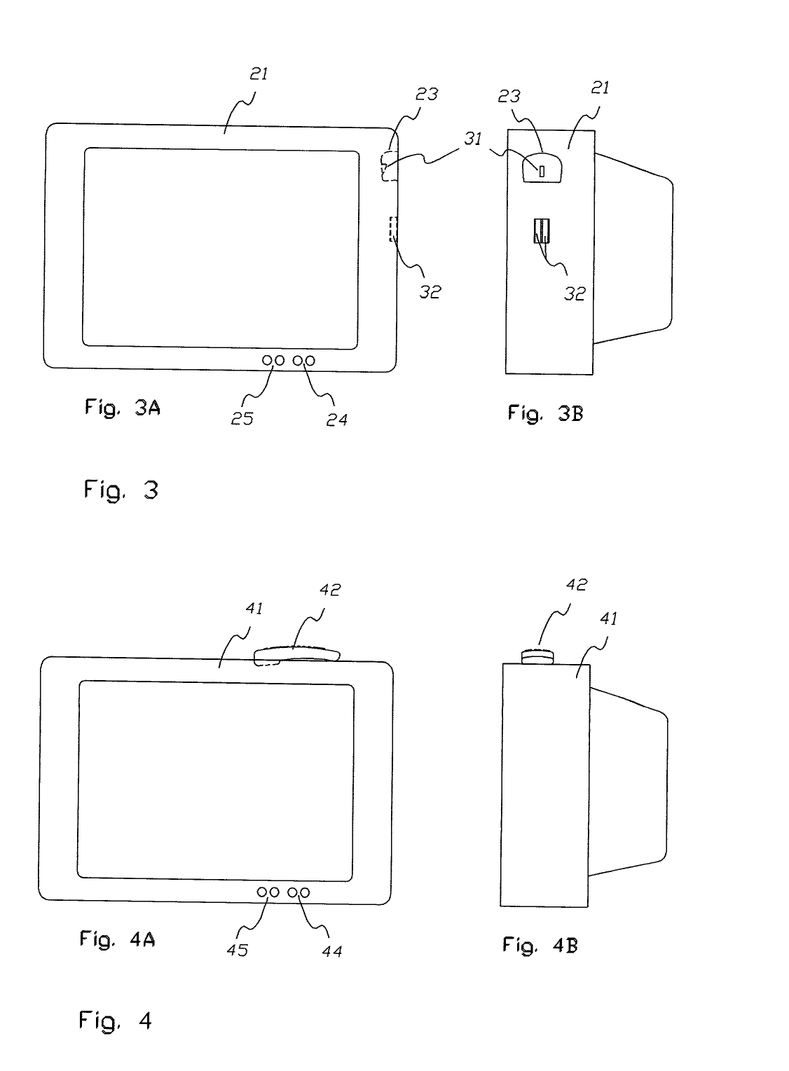

FIG. 3 shows more details (of FIG. 2 ) for the receptacle area with the remote control removed. A properly designed spring-loaded ON/OFF switch 31 is located in the receptacle such that the TV is OFF when the remote control is in the receptacle and it becomes ON when the remote control is removed from the receptacle. Since the remote control is shaped like a telephone's ear (/mouth) piece and the TV comes with a telephone like spring-loaded switch 31, any TV watcher would intuitively know the consequence of removal and replacement the remote control.

The operation of the invention is as followed. A TV watcher steps into the room, walks to the TV and picks up the remote control. Now the TV is ON. From here on, he may use the remote control as usual except that there is no ON/OFF function on the remote control. When he finished watching, he walks back to the TV and put the remote control back to the receptacle. Now the TV is OFF. The TV cannot be turned off until the remote control is back to its place (Of course, one can always unplug the power cable under the worst case scenario). Because of this restriction, a TV watcher is “forced” to place the remote control back to its place for the next watcher. This should eliminate almost all possibilities of a missing, or misplaced remote control.

Variations of design approaches may be used for this invention. One possibility is to use an optical sensor based ON/OFF switch. For example, removal of the remote control from the receptacle allows surrounding light to activate the ON switch.

One additional function for the receptacle (or receptacle area) is to allow storage of spare batteries. Extensive usage of a remote control can drain batteries quickly. Under the circumstance, if no fresh batteries are available immediately, it can be very disturbing to a TV watcher. In FIG. 3, battery holding features 32 are shown as a convenient way and place for spare batteries.

FIG. 4 shows an alternative embodiment in which the remote control 42 is designed to be placed in a flat position on the top of a TV 41. In this case, key features like Channel UP/DOWN buttons 44 and Volume UP/DOWN buttons 45 are similar in functions like those (24 and 25, respectively) shown in FIG. 2.

The invention also applies to a “combo” entertainment unit, for example, a TV/VCR (video recorder) unit. In this case, a typical remote control is even more indispensable due to its dual function to control both TV and VCR.

Although the above description contains a few specifications, these should not be construed as limiting the scope of the invention but as merely providing illustrations of some of the presently preferred embodiments of this invention.

1. A television with a built-in receptacle for its remote control.

2. In 1, said television's ON and OFF switch is activated by, respectively, removal and replacement of said remote control.

3. In 1, said receptacle also allows storage of spare batteries for said remote control.

4. An entertainment unit, comprising a television, with a built-in receptacle for its remote control.

5. In 4, said television's ON and OFF switch is activated by, respectively, removal and replacement of said remote control.

6. In 4, said receptacle also allows storage of spare batteries for said remote control.

7. A remote control, for a television, that can be placed in the receptacle of said television.

8. In 7, said remote control lacks the function to remotely turn on said television.

9. In 7, said remote control lacks the function to remotely turn off said television.
